(19) United States
(12) Patent Application Publication
(10) Pub. No.: US 2022/0128358 A1
(43) Pub. Date: Apr. 28, 2022

(54) Smart Sensor Based System and Method for Automatic Measurement of Water Level and Water Flow Velocity and Prediction

(71) Applicant: Burak Ozer, Perkasie, PA (US)

(72) Inventor: Burak Ozer, Perkasie, PA (US)

(21) Appl. No.: 17/510,242

(22) Filed: Oct. 25, 2021

Related U.S. Application Data
(63) Continuation of application No. 63/204,776, filed on Oct. 26, 2020.

(51) Int. Cl. G01C 13/00; G01P 5/00; G06N 3/04; G06T 7/90; G06T 7/13; G06T 7/136; G06T 5/00; G06T 5/40; G06T 5/20; G06T 7/246

(52) U.S. Cl. CPC G01C 13/008; G01P 5/00; G06N 3/0445; G06T 7/90; G06T 7/13; G06T 7/136; G06T 2207/20084; G06T 5/40; G06T 5/20; G06T 7/246; G06T 2207/30232; G06T 2207/20081; G06T 5/002

(57) ABSTRACT

Embodiments of the invention relate to methods and systems for measuring water level and water velocity and making predictions and risk assessment calculations. The method consists of several camera and sensor-based water level and water velocity processes that may be selected automatically to estimate the current level and velocity of a water body and predict water conditions by using real-time and historical data. The invention can trigger alarms based on benchmarks and thresholds set automatically using historical data or by the end-user.

### CROSS-REFERENCE TO RELATED APPLICATIONS

This application claims the benefit of U.S. Provisional Patent Application No. 63/204,776 filed on Oct. 26, 2020, the entire contents of which are hereby incorporated by reference herein.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The prior art for measuring water level and flow strength around rivers, lakes, canals, shores, and other water bodies depends on traditional measuring techniques, e.g. wire line method for measuring flow intensity, throwing ball and measuring the distance/time between two points for measuring flow velocity, or expensive electronic sensors, e.g. radar level sensors, pressure sensors, submersible sensors for water level measurement. While some of these systems need constant setup after each emergency, e.g., wire sensors, other sensors are only focused on a specific location and on a specific task. On the other hand, the invention covers a wide range of applications including but not limited to, real-time and continuous visual monitoring of a wide area under different weather conditions and performing different simultaneous analytics including but not limited to, measuring water level, flow direction and speed, correlating the findings to detect abnormalities, and making predictions regarding water condition.

### BRIEF SUMMARY OF THE INVENTION

Embodiments of the present invention satisfy these and other needs by providing a system and method that measure the water/mud level and the flow of the water/mud at rivers, lakes, flood areas, sea and other water related locations to save human life and property and predict water conditions by using real-time and historical data collected by the smart camera and other sensors. More specifically, embodiments of the invention relate to an apparatus and method that take real time video and images from cameras and other parameters including, but not limited to humidity, temperature, pressure, terrain information from other sensor and measure a) the water level and height by using low level features (e.g. color components, lines, motion vectors), high level temporal semantics (e.g. statistics of duration and repetition patterns corresponding to color models and mixture of color models, line models, group of motion vectors), b) the direction of the water flow and the velocity of the flow at different locations by using high level semantics (e.g. statistics (i.e. mean, variance of motion vector groups), analyze the data, and produce visual, audible, and other types of warnings and make predictions related to water level and water velocity by training the system with historical sensor and weather data to estimate water condition. Some of the locations where the invention can be used include but not limited to are rivers, lakes, possible flood areas, seashores, harbors, irrigation canals. The primary benefits of the invention are: a) The system proposes a robust solution to monitor water and mud and make predictions using deep learning algorithms under extreme weather conditions that other strategies cannot do. b) This non-contact sensor application is flexible, maintenance free, low cost and does not require any reflection boards/gauges like other sensors do. c) The system is adaptable for different applications without any extra cost to the user. The invention is a system that can assess risks related to the extreme weather conditions. The invention can also be mounted on multi-copter unmanned aircraft systems (UAS) besides stable cameras for data collection making them flexible, easy to use, and inexpensive.

In U.S. Pat. No. 10,996,687, a system is defined to monitor flood gates and closing the gates by a mechanical system that uses water level as one of the inputs. The method is dependent on finding the level by using pressure and touch based sensors. As stated by the inventor, the level sensors that can be used in their system are float switches, sonar sensors, water pressure sensors. However, these sensors are mostly touch based sensors and the major drawback of these sensors is that they need constant maintenance. Although there are multiple techniques for water management, prior solutions depend on traditional measuring tools and methods which need to be setup for each measurement and subsequently retrieved. They require extensive maintenance and are only focused on a specific location and on a specific task.

### BRIEF DESCRIPTION OF THE SEVERAL VIEWS OF THE DRAWING

It is noted that while the accompanying figures serve to illustrate the concepts that include the claimed invention, the claimed invention is not limited to the concepts displayed.

FIG. 1 is a flow diagram illustrating a simplified view of the invention, in accordance with embodiments of the invention;

FIGS. 2A and 2B are a flow diagram illustrating a method for measuring water level, in accordance with embodiments of the invention;

FIGS. 3A and 3B are a flow diagram illustrating a method for measuring the water level by using line-based algorithms, in accordance with embodiments of the invention;

FIGS. 4A and 4B are a flow diagram illustrating a method for measuring the water level by using optical flow-based algorithms, in accordance with embodiments of the invention;

FIG. 5 is a flow diagram illustrating a method for measuring the water level by using color-based algorithms, in accordance with embodiments of the invention;

FIG. 6 is a flow diagram illustrating a method for measuring the water velocity and water flow direction, in accordance with embodiments of the invention; and

FIG. 7 is a flow diagram illustrating a method for measuring the predicted water level, in accordance with embodiments of the invention.

It is to be understood that the attached drawings are for purposes of illustrating the concepts of the invention.

### DETAILED DESCRIPTION OF THE INVENTION

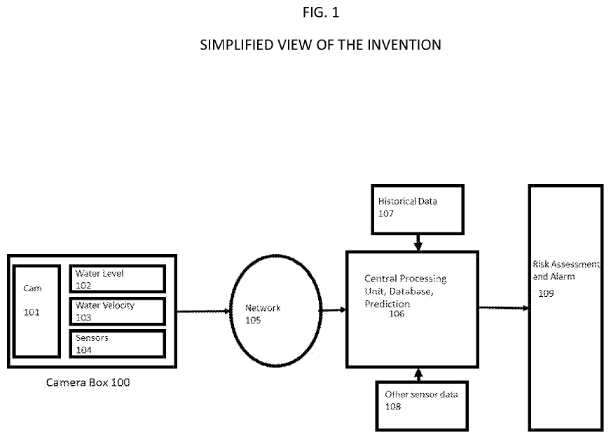

The system consists of several parts as shown in FIG. 1. The system consists of several sensors and is capable to process the input from different sensors in real-time and give warnings and/or alarms and make predictions regarding water and/or mud level and water and/or mud velocity. Inputs from video cameras (101), rain gauges and from other type of sensors (104, 108), that are located inside and outside of a camera box (100), are analyzed on the processing unit inside of the camera box. System can take different video inputs. Stored videos and real time videos from different camera sources can be processed. Water level measurement (102) and water velocity measurement (103) are performed by the processing unit in real-time. Level and velocity results, collected images and videos, and data collected by the sensors are sent to a central processing unit (106) via a wired or non-wired network (105) for further processing. Water level, velocity results, sensor outputs, images, videos from camera, historical water level data (107), weather data and other sensor data (108) are stored in the databases on the central processing unit (106). This data is further analyzed to make a final decision for water and/or mud level, water and/or mud flow direction, and water and/or mud velocity. Water/mud condition is predicted after these steps. Risk assessment and alarm generation are performed at the later stage (109).

### Water Level Detection

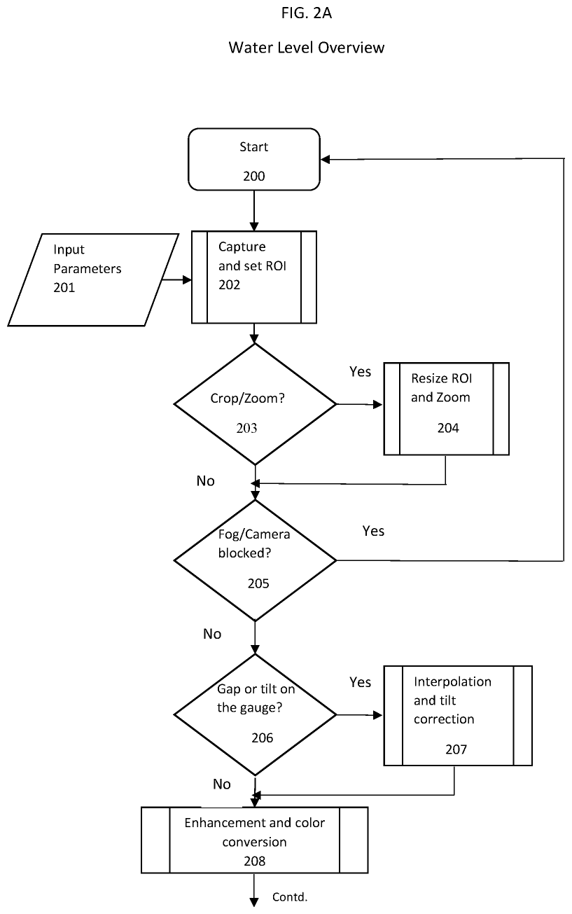

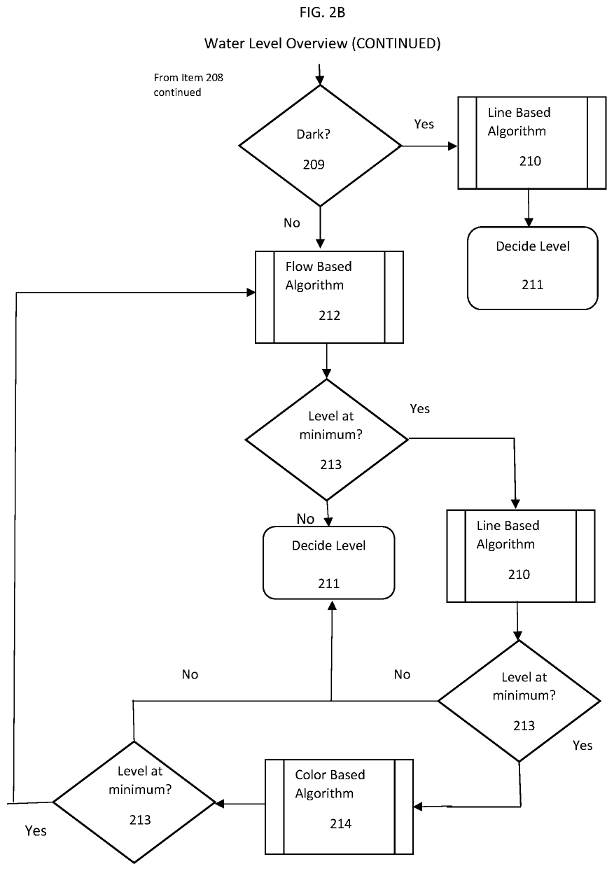

With reference to FIG. 2A and to FIG. 2B and continued reference to FIG. 1, this part (102) of embodiments of the invention relates to methods of measuring the water level by using camera and sensors. The approach is suitable to detect water and non-water areas within a predefined region of interest (ROI). Major parts of the embodiment include color-based detection, line-based detection method (210), flow-based detection method (212), and color-based detection method (214). The water level measuring algorithm is used with user pre-defined parameters (201). After capturing the frames from the camera, high level knowledge of the scene to extract region of interests (202) is performed. Region of interest can be set directly by the user through the parameter file, or it can be set automatically by the system by using template matching. A gauge template is used to find the highest correlation with the scene to find the approximate gauge area automatically if the user chooses this option. A close-up detection of the region of interest area is preferred under certain conditions, e.g., if there is a long distance between the camera and the region of interest area. The water gauge area is usually not well defined in the real-world environment. The traditional striped water gauges are hard to see by the camera since the camera is located far from the gauge or the paint on the gauge is striped off due to weather conditions. Some gauges are corroded. Some spots even don't have gauges. The system is equipped with a cropping and zooming method in the preprocessing unit (203) and (204). Cropping and zooming method is based on interpolation of pixels. The user can set zooming parameters in the parameter file. A noise elimination method is also performed in the preprocessing unit to eliminate the effects of outside factors. Fog/smoke detection, filtering, and image enhancement techniques are implemented at this stage (205). Possible camera blockage/heavy fog/heavy smoke check is performed to minimize false alarms in a pre-defined interval. Sobel edge detector based method checks the video frames for possible camera blockage/heavy fog/heavy smoke to minimize false alarms. The video frame is convolved with a Sobel kernel to find horizontal and vertical edges. The edges that are over certain thresholds are checked for a set of frames. The decision is made based on the pre-defined fog criteria. If there is no fog/blockage/smoke, gauge area is checked for possible gaps and tilts within ROI (206). This part (206) of the embodiments of the invention relates to methods of checking the gaps and possible tilt of the gauge area within ROI. Some gauges may have multiple segments and there may be a gap between these segments, some gauges may be tilted and may have a non-perpendicular angle with the water surface. A template with changing scale and rotation factors is moved automatically throughout the ROI area pixel by pixel in horizontal and vertical directions to find the maximum correlation with the gauge. Resulting correlation map further processed by thresholding the map and extracting the highest correlation points. The abstract representation of the correlation map enables the system to decide the gap location, if there is any, and the rotation of the gauge area. This part (207) of the embodiments of the invention relates to methods of interpolating the pixels around the gap area if there is a gap on the gauge, and of rotating the gauge area if there is a tilt found in part (206). Gauge pixels at the border of the gauge-gap area are interpolated and gap area pixels are replaced by the interpolated pixels. After interpolation, the ROI area is rotated by the angle value found in part (206).

This part (208) of embodiments of the invention relates to methods of enhancing the video frames and converting the color space to increase the reliability of the detection process. The color components are expanded in a non-linear way by using gamma correction where gamma represents the correction factor. Gamma correction's logarithmic kernel is shifted throughout each color component of the frame to enhance the pixels values and change the pixel values that are too low into pixels with higher values and change the pixel values with very high values into pixels that have lower value. Different color models as described in “Computer Vision: A Modern Approach,” by D. A. Forsyth and J. Ponce, published by Pearson Education in 2003 and “Color Appearance Models,” by Mark D. Fairchild, published by Addison-Wesley in 1988, may be used to convert color spaces. According to an embodiment of the present invention, RGB (red-green-blue), HSV, and YUV color spaces may be used separately or in combination, where YUV is a color model that has one luminance component (Y) and two chrominance components (U and V). HSV model has hue, saturation, and value. Different color spaces are especially important for the rest of the algorithm. Part (209) checks the luminance value (Y) and decides which algorithm to choose for water level calculation. If the luminance value is below a pre-defined threshold, line-based algorithm (210) is used to find the level since flow-based (212) and color-based (214) algorithms can't be implemented. If the luminance value is above the threshold, flow-based algorithm starts processing. Three water level detection algorithms switch automatically based on the frame number after flow-based algorithm start. Detection starts with the motion/flow-based detection module, if the level is not equal to the minimum level (213) and if a level is detected and if the level is stable for a number of frames, the system decides this level as the correct detected level for another set of frames (211). If the level does not satisfy frame and stability constraints, the system switches to the line-based algorithm (210). Similar stability and frame constraints are applied in this module. The detected line should be stable for a set of frame groups (temporal stability). The last detection module is the color-based detection module (214) if none of the previous constraints are satisfied.

### Water Level Detection Based on Line Fitting

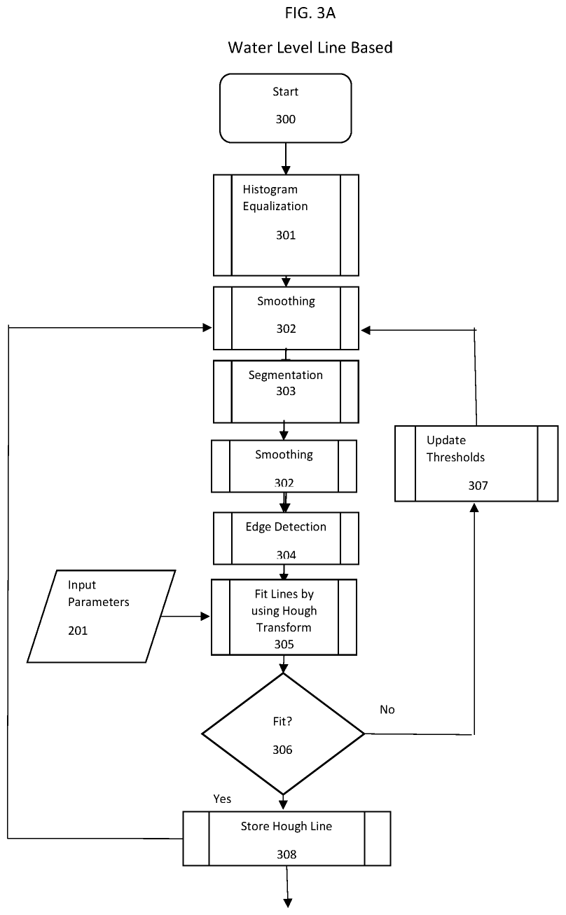

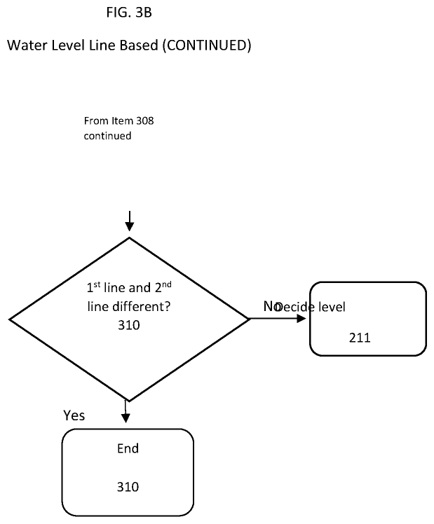

With reference to FIG. 3A and to FIG. 3B and continued reference to FIG. 2A and FIG. 2B, this part (210) of embodiments of the invention relates to methods of measuring the water level by using line-based methods. The images and/or video frames may be smoothed by histogram equalization (301) and by a low pass filter smoothing kernel (302) to reduce the effect of outside factors, e.g., sun glare, shadows, that may affect the image quality. Histogram equalization and smoothing are applied on the R (red) and G (green) and B (blue) components of the frame. Another histogram equalization and smoothing kernel are applied to the Y (luminance) components separately. This part (302) is followed by a segmentation algorithm (303) of the RGB components and luminance component separately. Candidate regions are selected where both segmentations show stable results within a set of frames. A commonly used mean-shift algorithm is used to segment the frames. After mean-shift algorithm implementation, for each frame, pixels are assigned to a segment class for RGB and Y components. After a certain frame number n, pixels that are not assigned to the same class for a number of frames m, where n>m, are eliminated. This process is repeated five times and pixels are grouped again for each iteration. The resulting grouped pixels show the segmentation result. Segmentation is followed by the smoothing part (302) to eliminate noise further.

This part (304) of embodiments of the invention relates to methods of finding the edges of the segmented areas before fitting lines to the edges. A high-pass filter is convolved with each frame to extract edges. High-pass filters enhance the high-frequency component and suppresses the low ones. Like segmentation part (303), edge pixels and non-edge pixels are classified into two groups. After a certain frame number n, pixels that are not assigned to the edge class for a number of frames m, where n>m, are eliminated. This process is repeated five times and edge pixels are grouped again for each iteration. For each edge within the ROI area a line is fitted by using Hough transform. The idea is finding straight lines within the ROI area from the edges. Fitted candidate lines are represented in polar coordinates. The user can put restrictions on the line detection space through the parameter file (201), e.g., the slope of the line. Good candidate lines are collected by a certain number of frames. The line should appear in each frame within this frame group. The line with the lowest row value within the ROI area is chosen as the best fit line (306). If there is no fit, the smoothing thresholds are updated (307) to find stronger edges. If there is a good fit, the line is stored as the best fit line (308). The fitting process is repeated for the next set of frames. There are two best fit lines after the second iteration. First and second lines are checked if they have a good match (310). If there is no match, line fitting process ends, otherwise the water level is detected (211).

### Water Level Detection Based on Flow

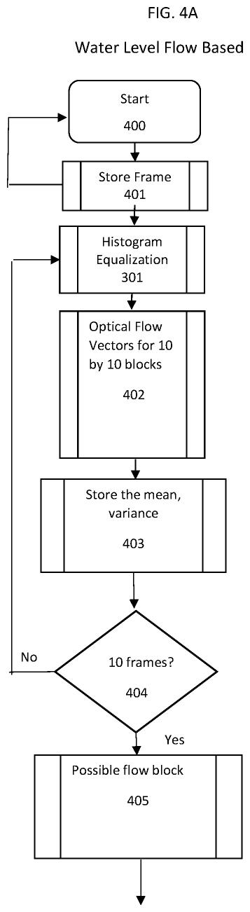

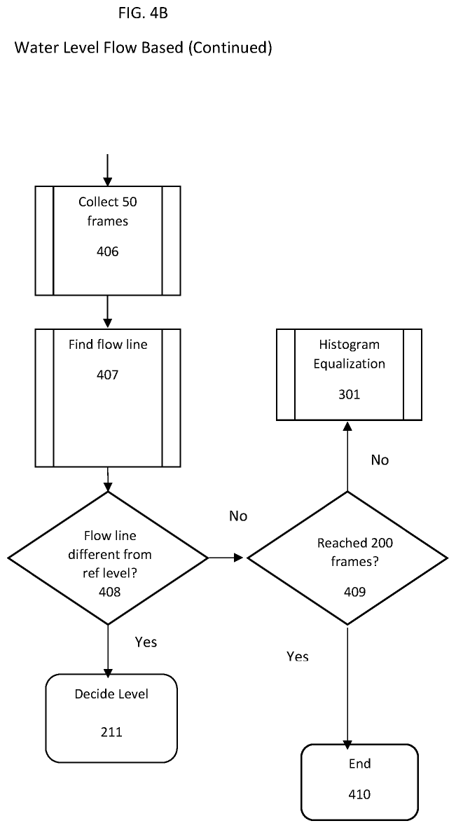

With reference to FIG. 4A and to FIG. 4B and continued reference to FIG. 2A and FIG. 2B, this part (212) of embodiments of the invention relates to methods of measuring the water level by using flow-based methods. Especially high-speed water flow increases the accuracy of the system since the color and line information under very heavy rain and under extreme weather conditions may be less accurate. This part (401) of an embodiment of the invention relates to storing a video frame with a pre-set interval for calculating the optical flow vectors. Histogram equalization (301) performed for the new incoming and stored frame. The optical flow vectors between stored and new incoming frame are computed in step 402. There are multiple dense optical flow techniques in the literature, e.g., a modified version of Farneback's dense optical algorithm can be used for its practicality, speed, and high accuracy. In this technique, polynomial expansion is used to find the displacement between the frames. The idea of polynomial expansion is to approximate some neighborhood of each pixel with a polynomial. Extracted motion vectors from a set of frames are grouped for each 10 by 10 block and the block size can be set by the user depending on the camera-water distance. Mean and variance of the motion vectors are calculated for each block for a set of frames and stored (403), (404). For example, a 10×10 block's mean and variance is calculated for 10 frames as a group and stored. For five 10-frame sets (in total 50 frames) the system makes another check for these groups. Steps 405 and 406 show this process. This way, anomalies or weak candidate regions are eliminated based on the group mean/variance. This part (407) of an embodiment of the invention relates to methods of finding the flow line before deciding that the flow line is the actual water level. In this step, the vectors are grouped further by their location as well as their direction. Hard thresholds are used to eliminate the small vectors, as well as large vectors which are outside of the standard deviation of the vector distribution for a particular block. Grouping the vectors based on their direction helps to remove the effect of rain and other moving objects in the scene other than flow area. For increasing the stability further, a spatio-temporal filter is implemented in this step. Step 408 checks if the flow level is different from the reference level and decides if the flow level is the detected water level. If flow level and reference level are the same level, first a frame check is performed (409), if frame number is below 200 frames, flow-based algorithm starts again from histogram equalization block (301).

### Water Level Detection Based on Color

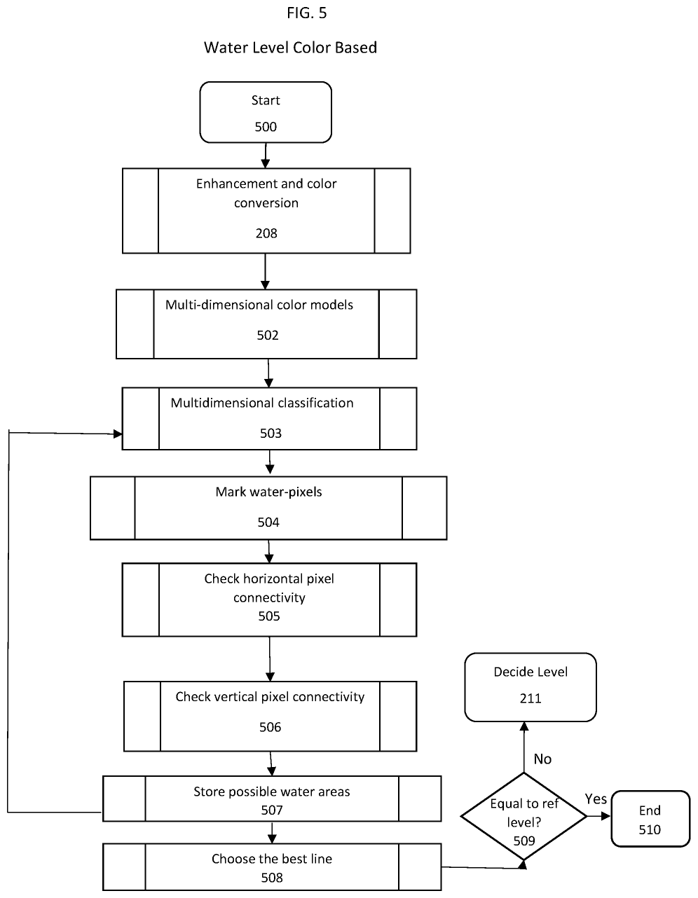

With reference to FIG. 5 and continued reference to FIG. 2A and FIG. 2B, this part (214) of embodiments of the invention relates to methods of measuring the water level by using color-based methods. If line-based and flow-based water level detection methods are not satisfied, the system automatically switches to color-based method. Enhancement and color space conversion (208) is the initial step of the algorithm. The system uses different color spaces. Each pixel in the ROI is represented by RGB, YUV and HSV values and the problem is handled as a multi-dimensional Bayesian classification problem for finding water and non-water areas. Within the ROI area, an initial segmentation is performed in step 502. Pixels that have color component values close to the mean of the color components of the upper most part of the ROI area and pixels that have color component values close to the mean of the bottom part of the ROI area are segmented initially into two classes. The problem can be defined as defining a quadratic boundary between water and non-water classes. Each pixel inside the gauge area is classified as water or non-water pixel. The problem becomes: Classify each pixel X in class ωᵢ if discriminant function gᵢ(X)>gⱼ(X). Each pixel has multiple color components, and each color component is represented by a different class. The classes are updated with each new frame (503). Besides statistical methods a non-statistical thresholding method to compare the distance of the pixels to the water and non-water areas is also used. Output of this stage gives candidate water/non-water pixels for the first set of frames (504). Each pixel's color components are compared with each classes' distribution statistics. If the pixel matches to one of the distributions, the mean and the covariance of the distribution are updated. This process is repeated for several set of frame groups to satisfy the water line stability condition. The sudden changes due to foam, waves, etc. and gaps due to wiper, branches in the water, tree leaves before the camera, etc. need to be considered by the system. A spatio-temporal filtering is used to reduce the effects of the above conditions. Each pixel within ROI area is assigned to water or non-water class based on the discriminant function. Steps 505 and 506 check the vertical and horizontal connectivity of these pixels, and pixels without any connectivity for a certain number of frames are eliminated. After elimination of non-connected pixels, each remaining pixel represents water or non-water areas, and they are marked accordingly (507). For stability purposes, the marked pixels are stored for another set of frames and a water-non-water line is chosen that segments the water and non-water areas in step 508. If the chosen level differs from the reference water level (509), the color-based level is set as the final water level value (211).

### Water Velocity

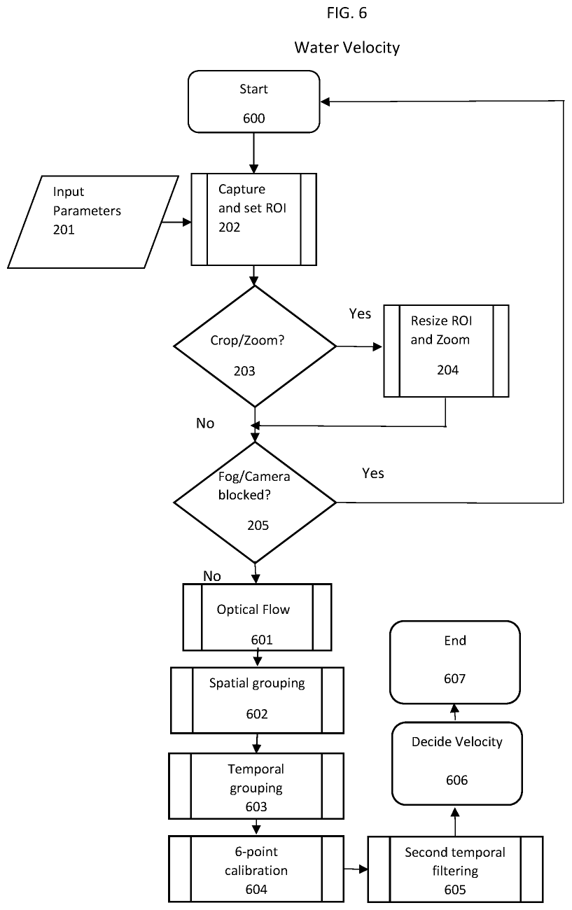

With reference to FIG. 6 and continued reference to FIG. 1, this part (103) of embodiments of the invention relates to methods of measuring the water velocity. The embodiment starts with pre-processing steps, namely 201, 202, 203, 204, and 205 that are used in the water level measuring algorithm. The system uses the modified version of the optical flow algorithm that is used in FIG. 4 (606). Optical flow calculation is a computationally costly process. Instead of using pixels directly from the image the system extracts strong edges on the water surface by an edge detector and implements the modified optical flow algorithm on the edge data between consecutive frames. This step is followed by a spatial grouping of vectors into blocks (602). The system chooses the most stable vector within each group after temporal filtering (603). Candidate motion vector for the block has been tested for a set of frames and its statistical information has been generated. If the vector is still within stability range, it is marked as the motion vector for that particular block. Actual frame rate and pre-calculated calibration data are used to make the pixel/frame to meter/second conversion of the motion vectors (604). There are multiple calibration algorithms. It is difficult to implement the widely known calibration algorithms for outdoor environments. The system uses a modified 6-point calibration algorithm to find the calibration parameters automatically. In this method, the major assumption is that only the back projection matrix for the water surface has been calculated which has zero height, which also means that the back projection is only calculated for he floor points. The back projection is represented as a line that goes through two points in space. Perspective point calibration is also used. Another temporal filtering is applied to remove rain/wiper/camera shake effect (605). The final velocity in world coordinates is decided in step 606. The velocity can be given in meter or feet per second and can be converted to miles or kilometer per hour.

### Prediction

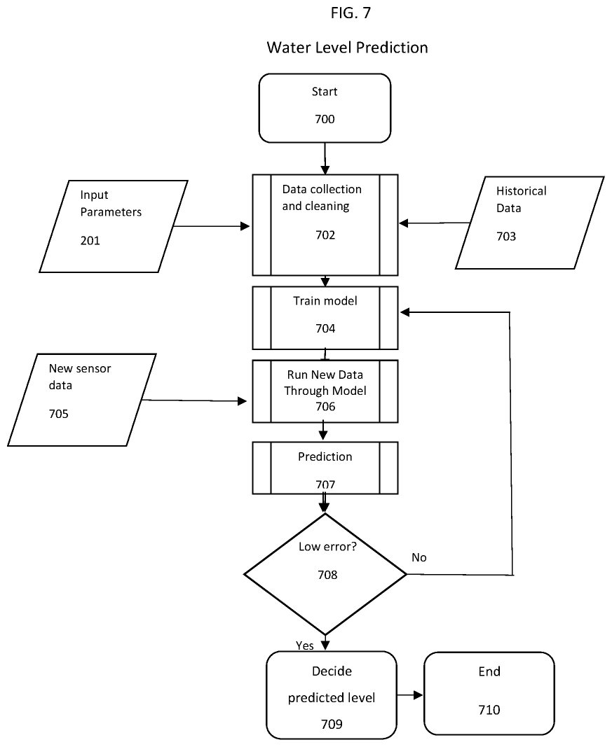

With reference to FIG. 7 and continued reference to FIG. 1, this part (106) of embodiments of the invention relates to methods of predicting the water level. There are three parts that are related to prediction of the water level, namely, a) collected historical data (703), b) sensor inputs including but not limited to camera data (water level), temperature, humidity, topological information, pressure (705), c) prediction algorithm. The camera module generates the data, namely, water level in foot/inch or meter/cm and water velocity in yard/second or meter/second. The data is stored on the camera module, and it is also sent to central processing unit (705) for data storage in a database to be used by neural networks to make predictions (702). Other type historical sensor data for a location is obtained by the user including but not limited to temperature change, rain amount from other databases, humidity, topological information. If the current sensor data is not available for this location, sensors (rain gauge, thermometer, barometer, etc.) are connected to the camera module as a peripheral. Sensors can also be mounted on the processing unit on an UAS.

Prediction can be performed on the central processing unit after real time data collection a) from camera module, b) from other sensors. The database is updated in real-time with each incoming data. Prediction can be performed on the camera processing unit attached to the camera. Neural network design for prediction of the future instances is similar to time series data prediction problem. Multiple inputs e.g., water level, sensor data, rain amount must be aligned correctly especially during the system training (704). The invention uses Long Short-Term Memory neural network algorithms at its core that are widely used for financial market predictions. The algorithm has been modified and adapted for water level predictions. Some prior research has been done in predicting water height using machine learning models. However, none of these attempts have led to a product which was ready for practical use. More specifically, it relates to the formatting of historical water level height and meteorological data and other sensor and non-sensor data of water body to train a Long short-term memory (LSTM) recurrent neural network (RNN) architecture, and subsequently using the model to predict future water level given historical, current, and predicted data. Of fundamental importance to this process is the removal of linear trends from data prior to both the training and practical use of the model, and the subsequent reinsertion of linear trends into initial predicted values to arrive at final predictions. The linear trend associated with a given predicted value is calculated based on the historical and established data associated with the water body during a certain period of time prior to predictions, namely the water level measurement for the water body in question. The model is capable of being re-trained based on new observations according to a user-defined frequency. The model is flexible with respect to prediction resolution, e.g., daily, hourly, 15-minute intervals; the resolution of predictions is equivalent to the resolution of the input data.

In more detail, first, historical and established data including, but not limited to, gauge height measurements (from cameras, drones, databases), rainfall measurements, humidity, temperature, soil type data (from sensors and databases), topographical data, and other available sensor and database data for this particular location are gathered. Next, data streams are created which retrieve updated or forecast data which correspond to the historical and established data previously gathered. Historical, established, updated, and forecast data are then collated into a single dataset. This dataset is then formatted and cleaned such that it includes only the desired data points at the desired frequency. After this, the dataset is detrended. This involves splitting the dataset into certain periods of time and removing the linear trend along the time axis from those periods.

Analyses are then performed on the existing data so that new features can be added to the data. The data then undergo further formatting such that they can be successfully run through the model. A decision is then made as to whether the data will be used to train a new model or the data will be passed through an existing model (704 and 706). If a new model is trained, forecast data is removed from the dataset and the resulting data is used to train a machine learning model. After the new model is trained, forecast data is reinserted into the dataset and the data points necessary to make a prediction are isolated and passed through the model (707). If a new model is not trained, the necessary data points are immediately isolated from the dataset and passed through an existing model. The resulting raw predictions are then collected. The appropriate linear trend previously removed from the raw data is then reinserted into the raw predictions in order to create the final predictions. If no model currently exists, a new model will have to be created. Likewise, if the current model performs below accepted performance standards (708), a new model will have to be created. A new model can also be created periodically such that the data used to train the model includes the latest available data. If the mean square error is below a threshold and if the current model performs above accepted performance, the predicted water level is accepted (709).

What is claimed is:

1. A method for measuring water level in a surveillance area, the method comprising the steps of using a processor, a camera, multiple sensors to perform the following steps:
extracting region of interest area automatically and identifying region of interest using color models, convolution, and correlation;
identifying camera blockage, gap, and tilt using edge detection, convolution, and correlation;
selecting an appropriate level detection algorithm using luminance, frame number, and output of level;
detecting water level under surveillance using line-based algorithm;
detecting water level under surveillance using flow-based algorithm; and
detecting water level under surveillance using color-based algorithm.

2. The method of claim 1, wherein the step of extracting the region of interest area automatically and identifying region of interest using color models, convolution, and correlation comprises the steps of:
computing color models of each frame and combining the color models;
analyzing region of interest by convolving a template for each color model;
computing correlation matrix and thresholding; and
determining region of interest.

3. The method of claim 1, wherein the step of identifying camera blockage, gap, and tilt using edge detection, convolution, and correlation comprises the steps of:
applying an edge detector and thresholding;
analyzing edges throughout frame for possible blockage;
analyzing gaps and tilt angle of region of interest using a template;
computing shape invariants of detection area; and
determining gaps and tilt angle.

4. The method of claim 1, wherein the step of selecting an appropriate level detection algorithm based on luminance, frame number, and output of level comprises selecting one or more water level detection algorithms.

5. The method of claim 1, wherein the step of detecting water level under surveillance using line-based algorithm comprises the steps of:
improving robustness using histogram equalization and smoothing color components;
identifying stable segments within region of interest;
applying spatio-temporal filters for improving robustness;
computing templates for low and high frequency components;
applying templates to extract edges and smooth regions;
fitting a line to extracted edges using parametric transforms; and
determining water level.

6. The method of claim 1, wherein the step of detecting water level under surveillance using flow-based algorithm comprises the steps of:
computing optical flow vectors for different block sizes;
estimating flow areas within each frame;
improving robustness of flow area estimation by grouping optical flow vectors in spatial and temporal domains;
identifying flow direction of each vector group and checking directional connectivity of each group;
improving robustness of flow area estimation by grouping optical flow vectors based on their direction;
determining flow and non-flow areas; and
determining water level.

7. The method of claim 1, wherein the step of detecting water level under surveillance using color-based algorithm comprises the steps of:
computing multidimensional color models for each frame;
computing Bayesian discriminant function for multidimensional classification;
identifying water and non-water pixels using discriminant function within region of interest;
analyzing horizontal and vertical connectivity of possible water areas;
improving robustness of water, non-water area decision using spatial and temporal filters; and
determining water level.

8. A method for measuring water velocity in a surveillance area, the method comprising the steps of using a processor, a camera, multiple sensors to perform the following steps:
computing dense optical flow vectors;
grouping optical flow vectors in spatial domain;
grouping optical flow vectors in temporal domain;
improving the robustness of the flow calculation with temporal statistics;
converting optical flow vectors from pixel coordinates to world coordinates using six point calibration; and
estimating the flow velocity.

9. A method for predicting water level in a surveillance area, the method comprising the steps of using a processor, a camera, multiple sensors to perform the following steps:
collecting sensor data from multiple sensors and formatting data;
training neural network models using historical sensor data and long-short-term-memory method;
performing prediction using current sensor data and trained models;
determining prediction error using modified long-short-term-memory neural network; and
predicting water level for different time frames.
